(19) United States
(12) Patent Application Publication
(10) Pub. No.: US 2016/0179884 A1
(43) Pub. Date: Jun. 23, 2016

(54) INTEGRATED EVENT PROCESSING AND DATABASE MANAGEMENT

(71) Applicants: Zbigniew Jerzak, Dresden (DE); Palaniappan Gandhi, Flossmoor, IL (US); Mark Theiding, Alameda, CA (US); Anil Kumar Goel, Waterloo (CA)

(72) Inventors: Zbigniew Jerzak, Dresden (DE); Palaniappan Gandhi, Flossmoor, IL (US); Mark Theiding, Alameda, CA (US); Anil Kumar Goel, Waterloo (CA)

(21) Appl. No.: 14/578,725

(22) Filed: Dec. 22, 2014

(51) Int. Cl. G06F 17/30

(52) U.S. Cl. CPC G06F 17/30442; G06F 17/30483

(57) ABSTRACT

Methods, systems, computer program products, and articles of manufacture for processing events and managing a database, are described. The events may be processed and the database may be managed using the same administrative tools. A database operation is performed based on a database query statement being a database operation statement type and an event processing project is managed based on the database query statement being a non-database operation statement type.

### RELATED APPLICATIONS

This application is related to U.S. application Ser. No. 14/318,279 filed Jun. 27, 2014, which application is incorporated in its entirety herein by reference.

### FIELD

The present disclosure relates, generally, to processing data events and managing databases. In an example embodiment, the disclosure relates to integrating the processing of data events and the management of a database system.

### BACKGROUND

Event processing and database management systems often work together but run on separate systems due to the resource-intensive nature of both tasks and because of the different ways in which the systems scale. The processing of data events typically triggers changes to the data residing in the database management system. Each event identifies one or more sets of operators that operate on the data residing in one or more rows of a database. The operators may be, for example, stateless stream operators or state-based window operators.

Conventionally, the event processing system and the database management system are designed and maintained as separate systems. This means that user management, such as user authentication and authorization, needs to be performed on separate systems. System management, such as data backups and starting and stopping servers and event processing projects may need to be performed using different tools. The monitoring of resources, such as the monitoring of processing resources and storage resources, may also need to be done using different tools. Thus, multiple systems must be designed, implemented and maintained, often using different types of tools.

### BRIEF DESCRIPTION OF DRAWINGS

The present disclosure is illustrated by way of example and not limitation in the figures of the accompanying drawings, in which like references indicate similar elements and in which:

FIGS. 1A and 1B illustrate schematic diagrams of example systems, in accordance with an example embodiment, for integrating the processing of data events and the management of a database system;

FIG. 2A is a diagram illustrating an example system for event stream processing, in accordance with an example embodiment;

FIG. 2B is a diagram illustrating an example event stream processing (ESP) engine, in accordance with an example embodiment;

FIG. 3 is a high-level logic diagram of an example integrated system, in accordance with an example embodiment, for processing data events and managing a database system;

FIG. 4A shows a representation of an example catalog for a database management server (DBMS), in accordance with an example embodiment;

FIG. 4B shows a representation of an example catalog of the DBMS with the incorporation of event processing artifacts, in accordance with an example embodiment;

FIG. 5 is a block diagram of an apparatus, in accordance with an example embodiment, for managing event processing in a DBMS;

FIG. 6 shows a workflow for creating the event processing project, in accordance with an example embodiment;

FIG. 7 shows a workflow for starting the event processing project, in accordance with an example embodiment;

FIG. 8 shows a workflow for creating a client connection, in accordance with an example embodiment;

FIG. 9 shows a flowchart of a method, in accordance with an example embodiment, for authorizing and authenticating a user;

FIG. 10 shows a flowchart of a method, in accordance with an example embodiment, for managing a catalog in a DBMS;

FIG. 11 shows a flowchart of a method, in accordance with one example embodiment for parsing a structured query language (SQL) statement;

FIG. 12 shows a flowchart of a method, in accordance with one example embodiment, for query processing in a DBMS;

FIG. 13 shows a flowchart of a method, in accordance with one example embodiment, for an event processing cluster manager in a DBMS;

FIG. 14 shows a flowchart of a method, in accordance with one example embodiment, for an event processing node manager;

FIG. 15 is a block diagram illustrating a mobile device, according to an example embodiment; and

FIG. 16 is a block diagram of a computer processing system within which a set of instructions may be executed for causing a computer to perform any one or more of the methodologies discussed herein.

### DETAILED DESCRIPTION

The description that follows includes illustrative systems, methods, techniques, instruction sequences, and computing program products that embody example embodiments of the present inventive subject matter. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Generally, methods, systems, apparatus, and computer program products for integrating the processing of events and the management of a database system are disclosed. The integrated system may provide for the effective management of the event processing and database management as a single application from, for example, a business perspective. In an example embodiment, a single tool may manage and/or monitor both the event processing and database management servers. In an example embodiment, event processing projects are maintained and exposed as entities in a database management catalog.

The events may be processed using stateless and state-based operators. Each event may identify one or more sets of operators that operate on the data in one or more rows of a database. A thread utilizing stateless operators, such as a stream operator thread utilizing stream operators, and/or a thread utilizing state-based operators, such as a window operator thread utilizing window operators, may process each event. Each thread may be mapped to a different type of column store. For example, a thread may be mapped to a local column store, a global column store, and the like. The thread may store at least a portion of the data resulting from processing the event in the corresponding column store.

In an example embodiment, a row/transaction identifier may be used to identify the data stored in the column store. The row/transaction identifier may identify the type of operation(s) performed to generate the data and may identify the row(s) in the database that have been impacted by the operation(s). The row/transaction identifier may thus provide access to the data associated with a specific version of one or more corresponding rows in the database following the processing of an event and/or the application of a set of operators to the data.

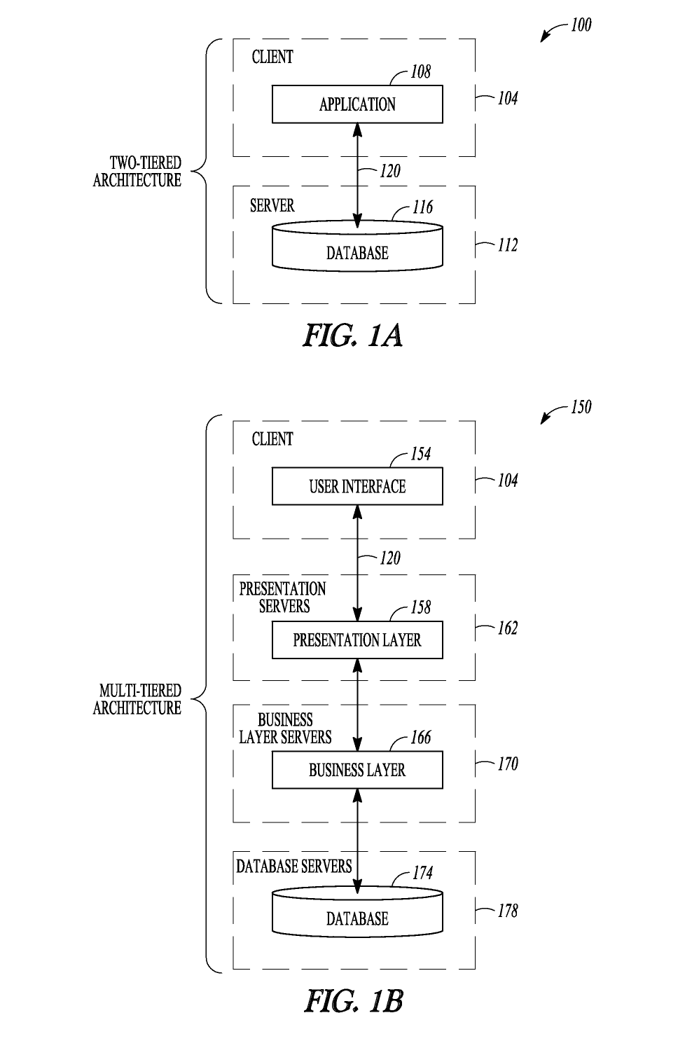

FIGS. 1A and 1B illustrate schematic diagrams of example systems, in accordance with an example embodiment, 100, 150 for integrating the processing of data events and the management of a database system. Traditional client-server systems may employ a two-tiered architecture such as that illustrated by system 100 in FIG. 1A. An application 108 executed on a client device 104 of the two-tiered architecture may be composed of a monolithic set of program code including a graphical user interface component, presentation logic, business logic, and a network interface that enables the client device 104 to communicate over a network 120 with one or more servers 112. A database 116 may be maintained on the server 112 that provides non-volatile or “persistent” storage for the data accessed and/or processed by the application 108.

The “business logic” component of the application 108 may represent the core program code of the application 108, i.e., the rules governing the underlying business process (or other functionality) provided by the application 108. The “presentation logic” may describe the specific manner in which the results of the business logic are formatted for display on the user interface. The database 116 may include data access logic used by the business logic to store and retrieve data.

In response to limitations associated with the two-tiered client-server architecture, a multi-tiered architecture has been developed, as illustrated in FIG. 1B. In the system 150, a presentation layer 158, business layer 166 and database 174 may be logically separated from the user interface 154 of the client device 104. These layers may be moved off of the client device 104 to one or more dedicated servers on the network 120. For example, the presentation layer 158, the business layer 166, and the database 174 may each be maintained on separate servers (e.g., presentation servers 162, business layer servers 170, and database servers 178).

This separation of logical components from the user interface 154 may provide a more flexible and scalable architecture compared to that provided by the two-tiered model of the system 100 in FIG. 1A. For example, the separation may ensure that all clients share a single implementation of the business layer 166. If business rules change, changing the current implementation of the business layer 166 to a new version may not call for updating any client-side program code. In addition, the presentation layer 158 may be provided, which generates code for a variety of different user interfaces 154, which may be standard browsers.

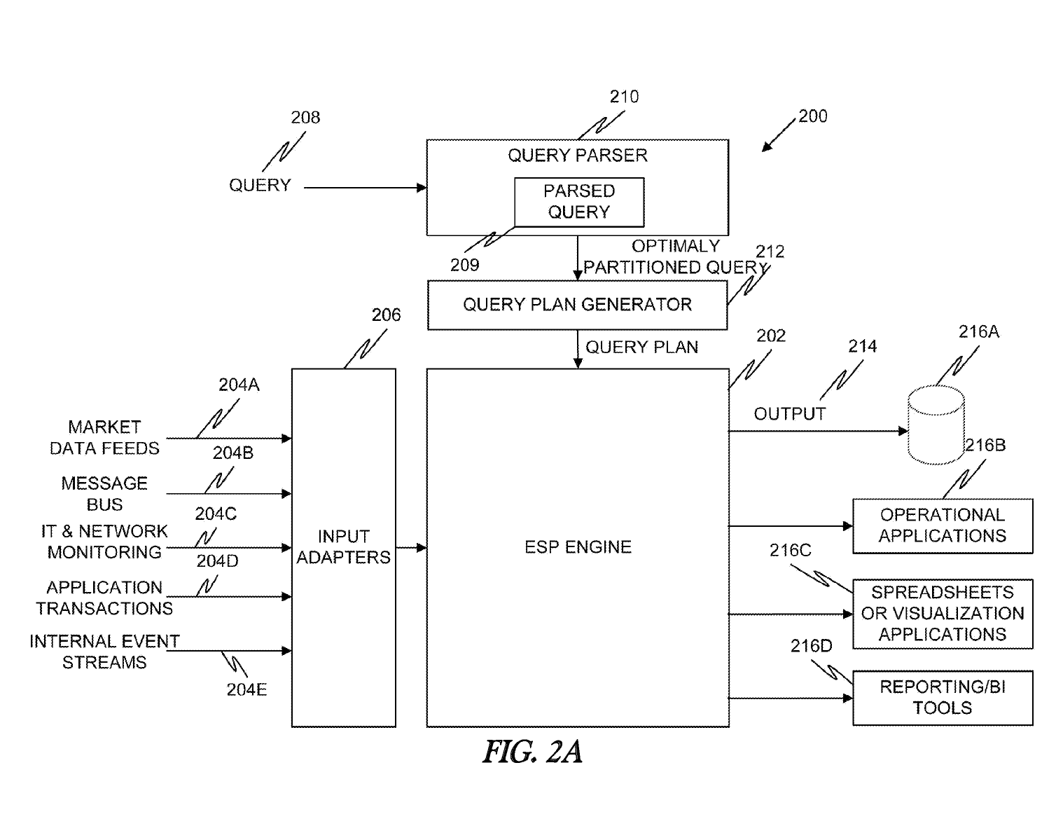

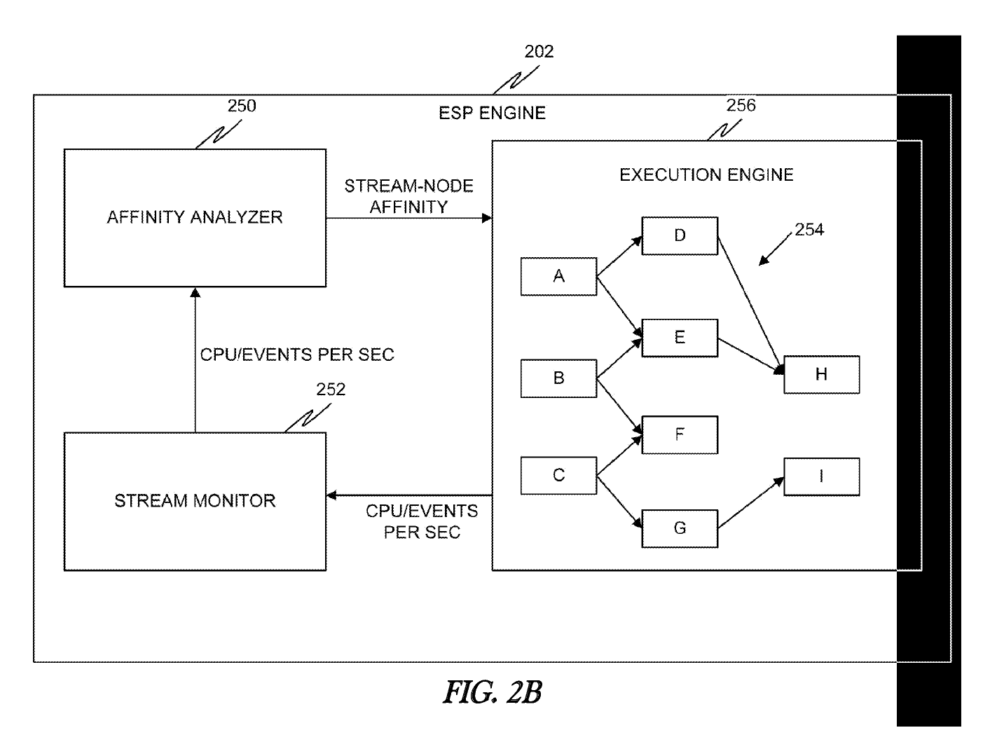

When data in the database 174 is changed, the data access logic of the database 116 (of FIG. 1A) may maintain a version of the data before the change and a version of the data after the change. The data access logic of the database 116 may generate a row/transaction identifier that identifies the row(s) of data in the database 116 that were modified and an operation code that identifies the type of operation(s) performed on the row(s) of the database 116, as described more fully below in conjunction with FIG. 2C. Each row/transaction identifier may be used by various threads and applications to access the data associated with a specific version of the corresponding row(s). In an example embodiment, a row/transaction identifier may be used to access the data associated with a specific version of a corresponding row(s) following the processing of an event and/or the application of a set of operators to the data in the database 116.

FIG. 2A is a diagram illustrating an example system 200 for event stream processing, in accordance with an example embodiment. An ESP engine 202 can receive one or more event streams 204A-204E via input adapters 206. The event streams 204A-204E can relate to, for example, market data feeds, message buses, network monitoring, application transactions, internal event streams, and so forth. A query 208 can be parsed by a query parser 210 to create a parsed query 209. The query parser 210 can decompose the parsed query 209 into a network of operators, with each operator representing an atomic processing block, and represent the parsed query 209 as a directed, acyclic graph (DAG). The parsed query 209 is passed to a query plan generator 212, which can generate a query plan based on the parsed query 209 and send the query plan to the ESP engine 202. The ESP engine 202 can then utilize the query plan to obtain appropriate data matching the query plan from the event streams 204A-204E, and send the data as output 214.

In an example embodiment, the output 214 can be sent to a variety of different possible destinations, including databases 216A, operational applications 216B, spreadsheets or visualization applications 216C, and reporting/business intelligence (BI) tools 216D.

FIG. 2B is a diagram illustrating an example ESP engine, in accordance with an example embodiment. In FIG. 2B, the ESP engine is labeled as ESP engine 252 because in one example embodiment, the ESP engine 252 is the same ESP engine 252 as described in FIG. 2A above. However, in some example embodiments, the ESP engine in FIG. 2B can be different than that as described in FIG. 1.

The ESP engine 252 can include an affinity analyzer 250. The affinity analyzer 250 can examine a number of input parameters to determine an affinity level for each complex event processing (CEP) thread in relation to a non-uniform memory access (NUMA) node. This affinity level can be called the “stream-node affinity.” The stream-node affinity can be determined both at startup time and periodically during runtime. During startup time, the affinity analyzer 250 can analyze the DAG and/or parsed ESP query to determine stream-node affinity. There are other factors that can influence the stream node affinity as well, such as the number of NUMA nodes and the number of CPUs per NUMA node. The user can also provide user input (e.g., hints) that can influence the analysis, such as an indication of whether threads are dynamic, semi-static, or static. The affinity analyzer 250 can also perform some predictive analysis to determine likely behavior of the threads. The goal of the affinity analyzer 250 is to balance the grouping of parent threads and children threads (threads that interact with the parent thread) to the same NUMA node while also distributing the load across all NUMA nodes. This helps ensure the least number of NUMA nodes are used to fit the entire graph while also ensuring that the graph uses nodes that are close to each other.

During runtime, a stream monitor 252 can monitor CPU/events per time period (e.g., second) for the streams. The affinity analyzer 250 can then identify CPU scarcity and CPU abundance in NUMA nodes and redistribute streams across the nodes. The affinity analyzer 250 can, for example, move streams from an overloaded CPU, starting with the least CPU requests first, until there is enough CPU capacity. The affinity analyzer 250 can also move streams to the closest NUMA node with available CPU capacity to minimize memory access times. The affinity analyzer 250 can also reevaluate the nearness of threads in case the determination at startup time was incorrect or has changed.

Returning to the startup time description, the affinity analyzer 250 can begin by analyzing the static structure of the CEP project and creating a fully connected thread graph 254 representing stream-node affinity, which can be passed to an execution engine 256 where each node represents a different project thread. Each node can be assigned a value representing the processing capacity requested by that thread. Edges between nodes can also be assigned a value, with this value representing the nearness of the threads the affinity analyzer 250 connects (the assigned edge value is higher when the nearness is higher). As requested processing capacity and thread nearness are functions of time and project load (i.e., they change over time and with different inputs), the affinity analyzer 250 can average/estimate across time and project load to assign the node and edge values.

The affinity analyzer 250 can then retrieve the number and size of NUMA nodes available. At this point, based on the input, the affinity analyzer 250 can create groups of threads. The total nearness of a group can be calculated by summing up the edges from the thread graph 254 between group members. The affinity analyzer 250 can then split the thread graph 254 into as many groups as there are NUMA nodes such that the sum of the groups' nearness is maximized, under the constraint that the groups' requested processing capacity is evenly balanced across groups. The affinity analyzer 250 can then assign each thread group to a different NUMA node.

In an example embodiment, the affinity analyzer 250 can take advantage of runtime information to determine that thread groups should change over time as thread nearness and thread processing capacity requirements change. At configurable intervals, the affinity analyzer 250 can re-evaluate optimal thread grouping based on current runtime information and adjust the assignment of threads to NUMA nodes as needed.

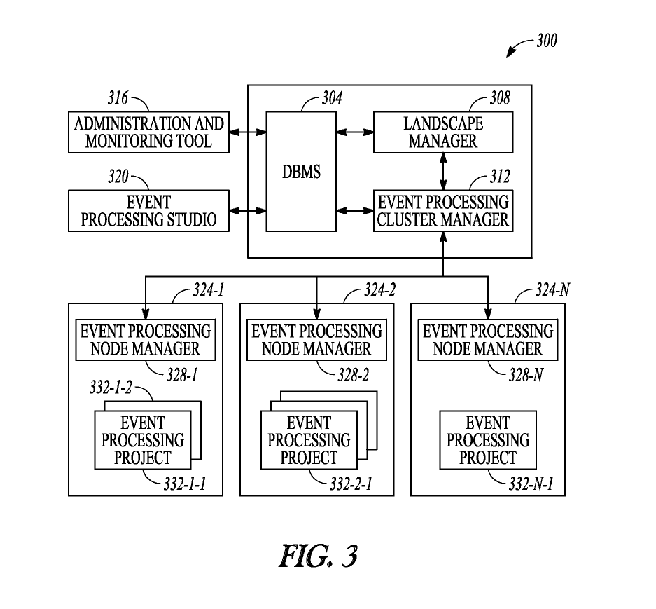

FIG. 3 is a high-level logic diagram of an example integrated system 300, in accordance with an example embodiment, for processing data events and managing a database system. In an example embodiment, a database management server (DBMS) 304 may act as a central repository for a portion or all of the event processing artifacts. The DBMS 304 may be responsible for storing information about the event processing projects, the streams/windows threads, the adapters, and the like in one or more of its catalogs. In an example embodiment, the DBMS 304 may act as the central point of contact for one or more of the event processing management activities. In an example embodiment, the DBMS 304 may act as the central point of initial contact for some or all of the event processing clients, such as for an event processing monitoring tool, an event processing administrative tool, and the like.

The DBMS 304 may be responsible for enforcing user authentication and authorization. In an example embodiment, the same user can be authorized to access and/or execute database entities, such as tables, procedures, views, and the like, and event processing entities, such as streaming entities including windows/streams threads, adapters, and the like.

The DBMS 304 may maintain information regarding the event processing projects. For example, the DBMS 304 may maintain information indicating whether an event processing project is running or is stopped and may maintain the identity of the event processing node on which the particular project is running

The landscape manager 308 may act as a repository for data associated with some or all of the event processing nodes 324-1, . . . 324-N (hereinafter collectively known as event processing nodes 324) and one or more database nodes (not shown). When an event processing node 324 is added to the integrated system 300, details about the event processing node 324 are added to the landscape manager 308. The information on the event processing nodes 324 maintained by the landscape manager 308 may be used by the event processing cluster manager 312 to, for example, determine on which of the event processing nodes 324 to deploy one of the event processing projects 332-1-1, . . . 332-N-1 (hereinafter collectively known as event processing projects 332).

The event processing cluster manager 312 may be responsible for monitoring the event processing projects 332 and deciding on which of the event processing nodes 324 to deploy one of the event processing projects 332 (if an event processing node 324 is not explicitly identified). The event processing cluster manager 312 may ask the appropriate event processing node manager 328-1, . . . 328-N (hereinafter collectively known as event processing node managers 328) to start or stop one of the event processing projects 332 that is being executed by the corresponding event processing node 324. The DBMS 304 may communicate with the event processing cluster manager 312 when an event processing project 332 and/or adapter needs to be started or stopped.

The event processing node manager 328 may own, administer, and/or control the event processing projects 332 running on a corresponding event processing node 324. In an example embodiment, there is one event processing node manager 328 for each event processing node 324.

The event processing studio 320 may be used to author and/or deploy an event processing project 332. When the event processing project 332 is deployed, catalog entries for all the project artifacts, such as streams, windows, adapters and the like, may be created in the DBMS 304. The event processing studio 320 may also store the source and compiled code in the DBMS 304 thereby enabling it to be edited at a future time.

The administration and monitoring tool 316 can be used to add users and give them authorization to, for example, start and/or stop projects and adapters, publish and subscribe to event processing projects 332, and the like. The administration and monitoring tool 316 may also be used to monitor the DBMS 304, monitor the state and resource usage of the event processing projects 332, and the like. In an example embodiment, the administration and monitoring tool 316 may request monitoring information from the DBMS 304 for an individual event processing project 332. The DBMS 304 may propagate this request to the event processing cluster manager 312, which may retrieve the information from the individual event processing projects 332.

In an example embodiment, the monitoring and management of the event processing projects 332 can be achieved in substantially the same way as monitoring and managing the DBMS 304 from, for example, an administrator's perspective. In an example embodiment, some or all of the event processing administration-related tasks may be executed against the DBMS 304 from the administration and monitoring tool 316 using, for example, SQL statements. For example, the statement CREATE PROJECT X may be used to create the artifacts of the event processing project 332 in the DBMS 304. The statement START PROJECT X may be used to start a project; the statement STOP PROJECT X may be used to stop a running project; and the statement START ADAPTER X.Adapter1 may be used to start the specified adapter in project X.

Similarly, event processing authorization-related tasks, such as creating users, roles, various event processing related privileges, and the like, may be performed on the DBMS 304 using the same tools and procedures used for the DBMS 304. Some authorization-related commands may overlap with a traditional database while some may be special to event processing. Even though some privileges, such as starting or stopping adapters, may not be relevant to the database(s) in the DBMS 304, the DBMS 304 is able to honor the privileges because it is aware that these privileges are for streaming entities. In an example embodiment, examples of authorization-related statements may include:
GRANT READ ON X.Window1 to query an event processing Window;
GRANT SUBSCRIBE ON X.Stream to subscribe to an event processing stream;
GRANT PUBLISH ON X.InputStream to send insert/update and delete requests; and
GRANT ALL_PRIVILEGES ON X to grant all privileges for the project X.

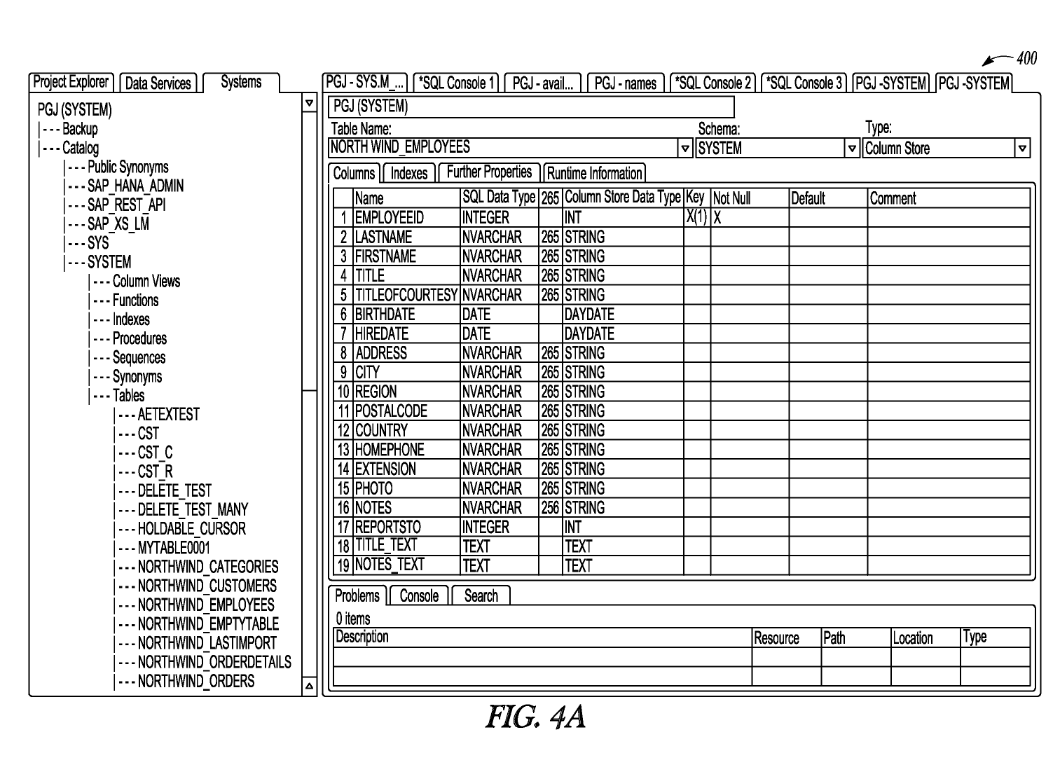

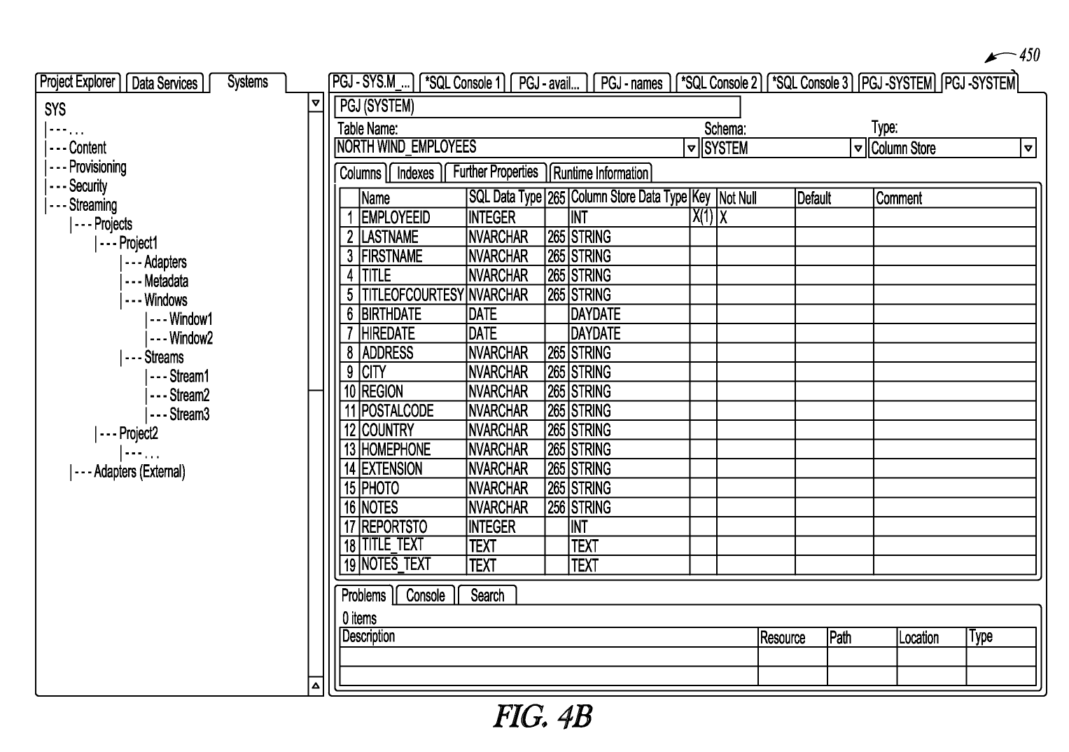

FIG. 4A shows a representation 400 of an example catalog for the DBMS 304, in accordance with one example embodiment. As illustrated in FIG. 4A, the SYSTEM directory may comprise functions, procedures, tables, triggers, views, and the like that are associated with a database. FIG. 4B shows a representation 450 of an example catalog of the DBMS 304 with the incorporation of event processing artifacts, in accordance with one example embodiment. As illustrated in FIG. 4B, the SYS directory may comprise, for example, streaming entities, such as streaming projects. The streaming projects may comprise, for example, metadata, streams, windows, adapters, and the like. The streams may be associated with a set of one or more stateless operators and the windows may be associated with a set of one or more state-based operators for processing data events.

In an example embodiment, clicking on the window or stream in the SYS directory may provide information about the definition of the stream or window stored in the DBMS 304 in a manner similar to obtaining information about a database table or view. The SYS directory may also grant privileges on the streaming objects.

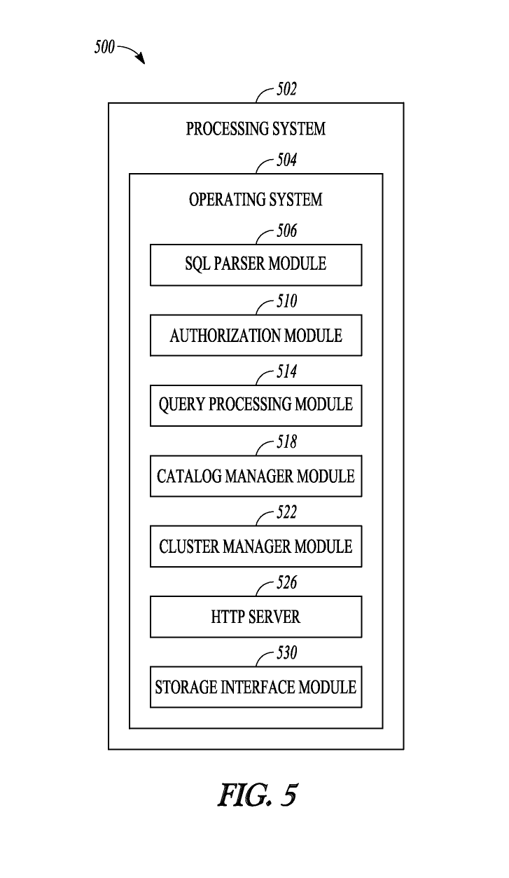

FIG. 5 is a block diagram of an example apparatus 500, in accordance with an example embodiment, for managing event processing in a DBMS 304. The apparatus 500 is shown to include a processing system 502 that may be implemented on a server, client, or other processing device that includes an operating system 504 for executing software instructions. In accordance with an example embodiment, the apparatus 500 may include an SQL parser module 506, an authorization module 510, a query processing module 514, a catalog manager module 518, a cluster manager module 522, an hypertext transfer protocol (HTTP) server 526, and a storage interface module 530.

The SQL parser module 506 may be responsible for parsing SQL statements received by the DBMS 304 and creating a statement tree. The SQL parser module 506 may issue an authorization check to the authorization module 510 in order to confirm that the user is authorized to create a project or perform other tasks.

The authorization module 510 may check whether a user is authorized to request a particular action. For example, the authorization module 510 may check whether a user is authorized to issue an SQL statement received by the SQL parser module 506.

The query processing module 514 may be responsible for processing queries issued to the DBMS 304. For example, the query processing module 514 may be responsible for processing an SQL statement received by the DBMS 304. The query processing module 514 may also create catalog entries in one or more catalogs of the DBMS 304. The query processing module 514 may also obtain the artifacts associated with the event processing project 332 and may issue a start project command to the appropriate event processing node manager 328.

The catalog manager module 518 may be responsible for managing and providing access to the catalog(s) of the DBMS 304. The catalog manager module 518 may be responsible for updating the status of the event processing projects 332 in the catalog(s) of the DBMS 304.

The cluster manager module 522 may implement the event processing cluster manager 312 and may be responsible for monitoring the event processing projects 332 and deciding on which of the event processing nodes 324 to deploy one of the event processing projects 332 (if an event processing node 324 is not explicitly identified). The cluster manager module 522 may instruct the appropriate event processing node manager 328 to start or stop one of the event processing projects 332 that is being executed by the corresponding event processing node 324.

The HTTP server 526 may process requests for project connection information. The HTTP server 526 may, in turn, request and obtain the project connection information from the catalog manager module 518. The storage interface module 530 may provide access to various storage elements, such as the column stores and catalog(s) of the DBMS 304, as described more fully above in conjunction with FIG. 2B.

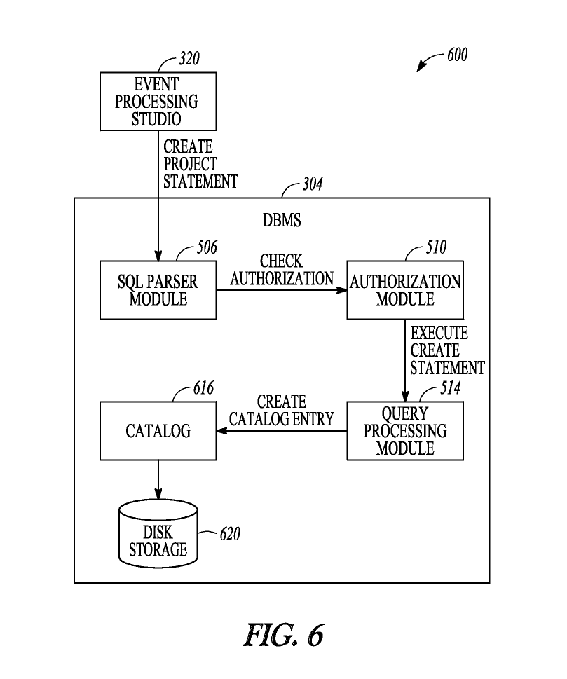

FIG. 6 shows a workflow 600 for creating the event processing project 332, in accordance with one example embodiment. In an example embodiment, the event processing studio 320 may issue a create project statement to a SQL parser module 506. As illustrated in FIG. 6, the SQL parser module 506 may be a component of the DBMS 304. The SQL parser module 506 may parse the create project statement to create a SQL statement tree and may issue an authorization check to the authorization module 510 in order to confirm that the user is authorized to create the project. If the user is not authorized, an error message (not shown) may be returned to the event processing studio 320. If the user is authorized, an execute create statement may be issued by, for example, the authorization module 510 to the query processing module 514. The query processing module 514 may, in turn, create one or more catalog entries in one or more catalogs 616. In an example embodiment, one or more of the entries in the catalog(s) 616 may be stored to a disk storage 620 in response to the creation of the entry in the catalog(s) 616 or may be stored to disk storage 620 at a future time.

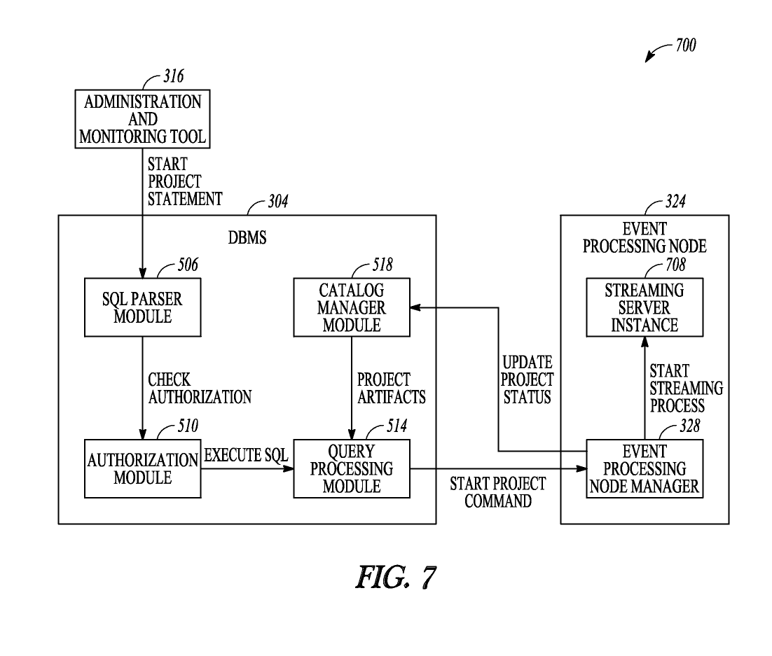

FIG. 7 shows a workflow 700 for starting the event processing project 332, in accordance with one example embodiment. In an example embodiment, the administration and monitoring tool 316 may issue a start project statement to the SQL parser module 506. The SQL parser module 506 may parse the start project statement and create a statement tree, and may issue an authorization check to the authorization module 510 in order to confirm that the user is authorized to start the event processing project 332. If the user is not authorized, an error message (not shown) may be returned to the administration and monitoring tool 316. If the user is authorized, an execute SQL statement may be issued by, for example, the authorization module 510 to the query processing module 514. The query processing module 514 may, in turn, obtain the artifacts associated with the event processing project 332 to be started and may issue a start project command to the appropriate event processing node manager 328. The event processing node manager 328 may start the corresponding event streaming process on a streaming server instance 708 to execute the set of operators for conducting the event processing. During and/or upon completion of the execution of the set of operators, the event processing node manager 328 may update the project status via the catalog manager module 518.

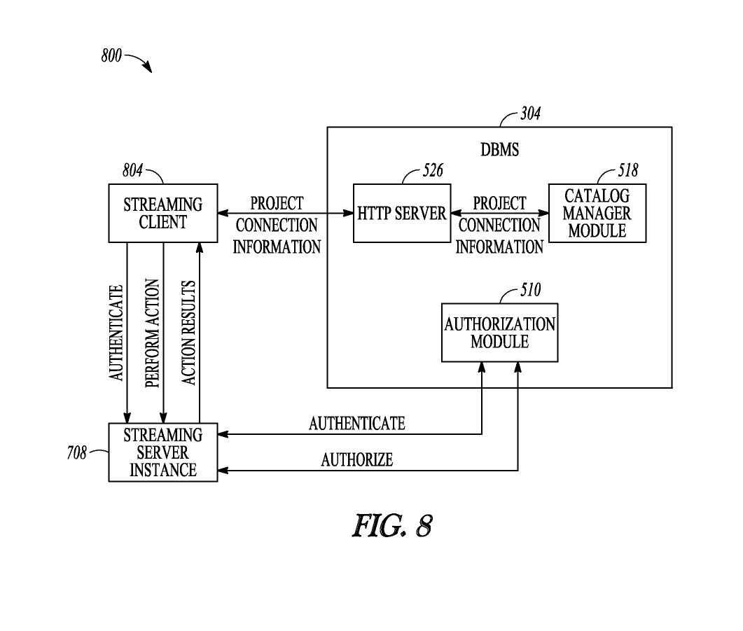

FIG. 8 shows a workflow 800 for creating a client connection, in accordance with one example embodiment. In an example embodiment, a streaming client 804 may request and obtain project connection information from the HTTP server 526 of the DBMS 304. The HTTP server 526 may, in turn, request and obtain the project connection information from the catalog manager module 518.

The streaming client 804 may issue an authentication check to a streaming server instance 708 of the event processing node 324 in order to confirm the identity of the user. The streaming server instance 708 may, in turn, issue an authentication check to the authorization module 510. If the user is not authenticated, an error message (not shown) may be returned to the streaming client 804. If the user is authenticated, an authentication message may be returned to the streaming client 804 and the streaming client 804 may issue commands to perform various actions to the streaming server instance 708.

The streaming server instance 708 may issue an authorization check to the authorization module 510 in order to confirm that the user is authorized to perform the specified actions. If the user is not authorized, an error message (not shown) may be returned to the streaming client 804 via the streaming server instance 708. If the user is authorized, the streaming server instance 708 may perform the specified actions and may return the action results to the streaming client 804.

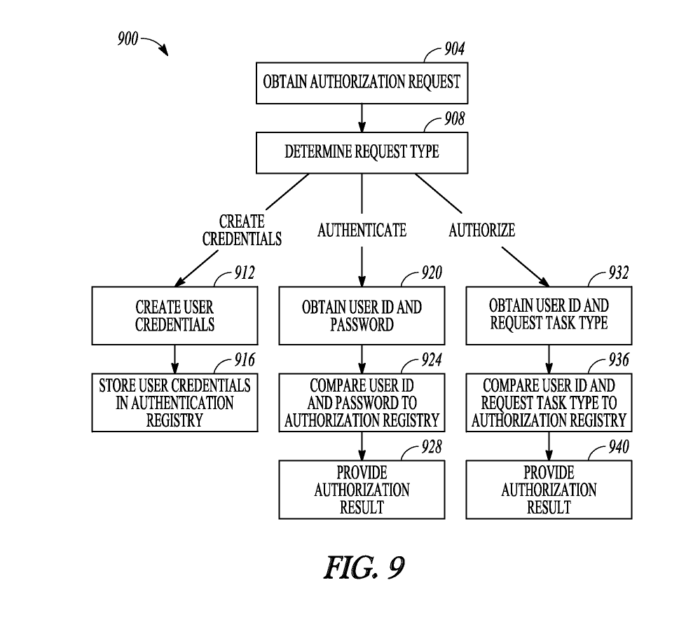

FIG. 9 shows a flowchart of a method 900, in accordance with one example embodiment, for authorizing and authenticating a user. In an example embodiment, one or more of the operations of method 900 may be performed by the authorization module 510.

In an example embodiment, an authorization request may be obtained (operation 904) and the type of authorization request may be determined (operation 908). If the authorization request is a request to create credentials, the user credentials may be created (operation 912) and may be stored in an authentication registry (operation 916). If the authorization request is a request to authenticate a user, the user's identification and password may be obtained (operation 920) and compared to the credentials stored in the authentication registry (operation 924). The results of the authentication are then returned (operation 928).

If the authorization request is a request to check a user's authorization to perform a task, the identity of the user and the type of the requested task are obtained (operation 932) and the user's identity and requested task type are compared to an authorization registry (operation 936). The authorization results are then returned (operation 940).

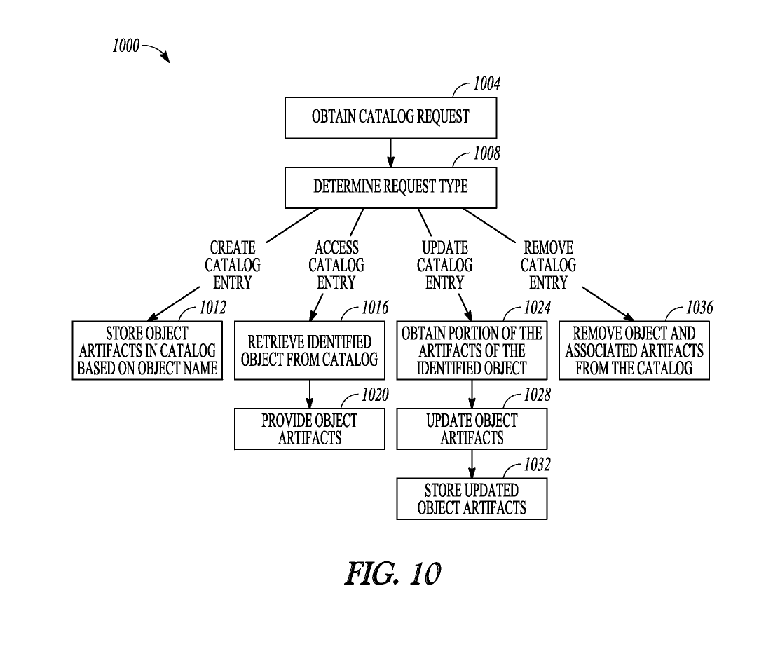

FIG. 10 shows a flowchart of a method 1000, in accordance with one example embodiment, for managing a catalog in a DBMS 304. In an example embodiment, one or more of the operations of method 1000 may be performed by the catalog manager module 518.

In an example embodiment, a catalog request may be obtained (operation 1004) and the type of catalog request may be determined (operation 1008). If the catalog request is a request to create a catalog entry, the artifacts of the object(s) corresponding to the catalog entry may be stored in the catalog based on the name(s) of the object(s) in the catalog request (operation 1012). If the catalog request is a request to access a catalog entry, the object identified in the request may be retrieved from the catalog (operation 1016) and the retrieved artifacts may be returned (operation 1020).

If the catalog request is a request to update a catalog entry, a portion of the artifacts of the object identified in the request may be retrieved from the catalog (operation 1024), the appropriate artifacts may be updated in accordance with the request (operation 1028), and the updated artifacts may be stored in the corresponding calendar entry (operation 1032). If the catalog request is a request to delete a catalog entry, the object identified in the request and the object's artifacts may be removed from the catalog (operation 1036).

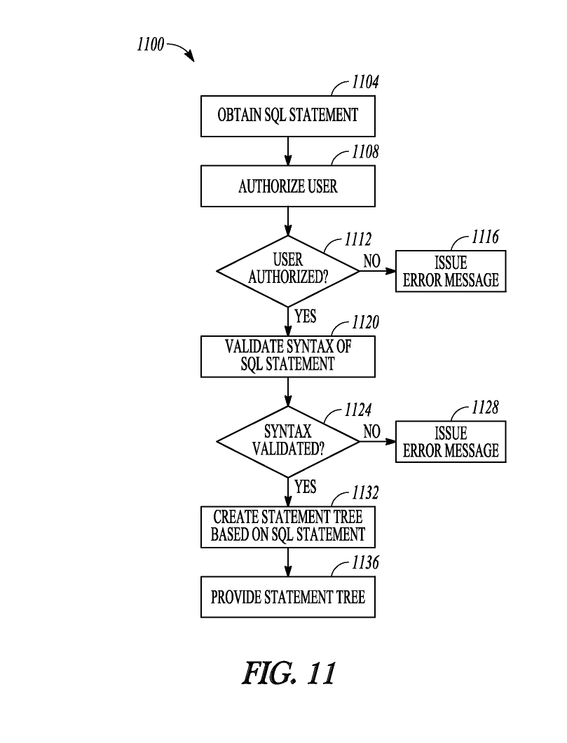

FIG. 11 shows a flowchart of an example method 1100 for parsing an SQL statement, in accordance with one example embodiment. In an example embodiment, one or more of the operations of method 1100 may be performed by the SQL parser module 506.

In an example embodiment, an SQL statement may be obtained (operation 1104) and the authorization of the user may be checked to determine if the user is authorized to issue the obtained SQL statement (operation 1108). A test may be performed to determine if the user was authorized (operation 1112). If the user is not authorized, an error message may be issued (operation 1116); otherwise, the SQL statement may be analyzed to determine if it conforms to the SQL syntax (operation 1120). A test may be performed to determine if the SQL statement was validated (operation 1124). If the SQL statement is not valid, an error message may be issued (operation 1128); otherwise, a statement tree may be created based on the obtained SQL statement (operation 1132). The created statement tree may be returned (operation 1136).

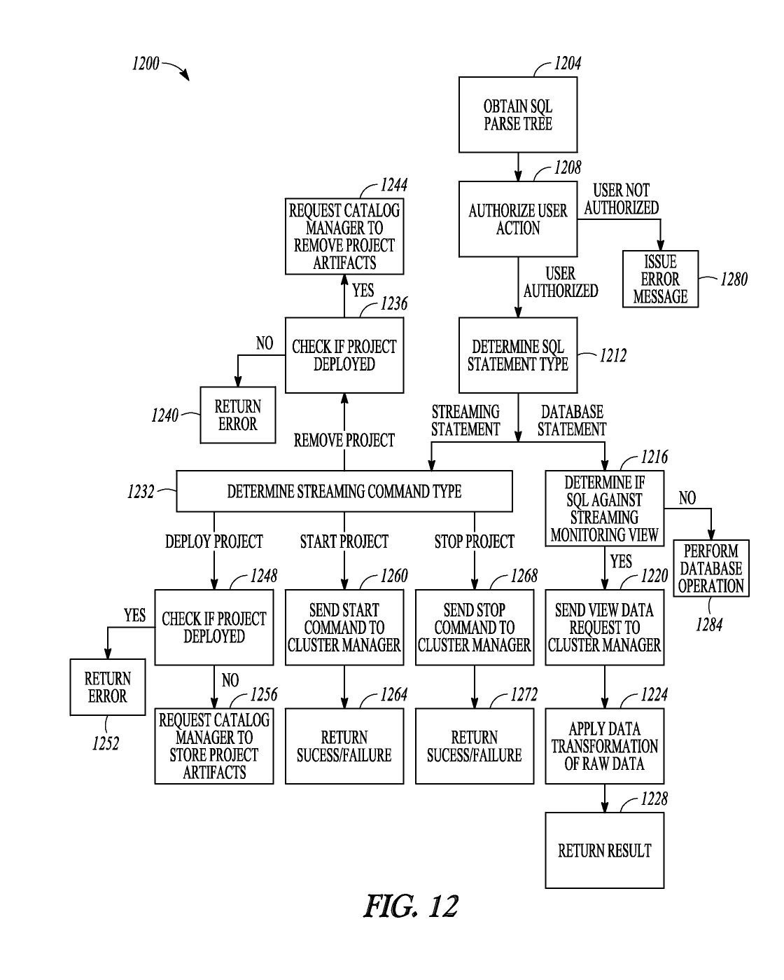

FIG. 12 shows a flowchart of an example method 1200 for query processing in an integrated DBMS 304, in accordance with one example embodiment. In an example embodiment, one or more of the operations of method 1200 may be performed by the query processing module 514.

In an example embodiment, an SQL parse tree may be obtained (operation 1204) and the requesting user's authorization to perform the operations of the SQL parse tree may be validated (operation 1208). For example, the authorization module 510 may be called to determine if the requesting user is authorized. If the user is not authorized, an error message may be issued (operation 1280); otherwise, the type of SQL statement may be determined (operation 1212). For example, a test may be performed to determine if the SQL statement type is a database statement or a streaming statement. If the SQL statement type is a database statement, the method 1200 may proceed with operation 1216; if the SQL statement type is a streaming statement, the method 1200 may proceed with operation 1232.

If the SQL statement type is a database statement, a test may be performed to determine if the query is against a streaming monitoring view (operation 1216). If the query is not against a streaming monitoring view, a conventional database query may be performed (operation 1284). If the query is against a streaming monitoring view, a view data request is sent to the event processing cluster manager 312 to obtain the raw data of the monitoring information (operation 1220). The raw data of the received monitoring information may be transformed to conform to the format of the requesting entity (operation 1224) and the transformed monitoring information may be returned (operation 1228).

If the SQL statement type is a streaming statement, a test may be performed to determine the type of the streaming command (operation 1232). If the type of streaming command is a remove project command, a test may be performed to determine if the project identified in the streaming statement has been deployed (operation 1236). If the project has not been deployed, an error message may be issued (operation 1240); otherwise, a request may be submitted to the catalog manager module 518 to remove the artifacts of the project identified in the streaming statement (operation 1244).

If the type of streaming command is a deploy project command, a test may be performed to determine if the project identified in the streaming statement has already been deployed (operation 1248). If the streaming statement has been deployed, an error message may be issued (operation 1252); otherwise, a request may be submitted to the catalog manager module 518 to store the artifacts of the project identified in the streaming statement in the catalog 616 (operation 1256).

If the type of streaming command is a start project command, a start command may be sent to the event processing cluster manager 312 (operation 1260) and, based on the response from the event processing cluster manager 312, a success or failure message may be returned (operation 1264).

If the type of streaming command is a stop project command, a stop command is sent to the event processing cluster manager 312 (operation 1268) and, based on the response from the event processing cluster manager 312, a success or failure message is returned (operation 1272).

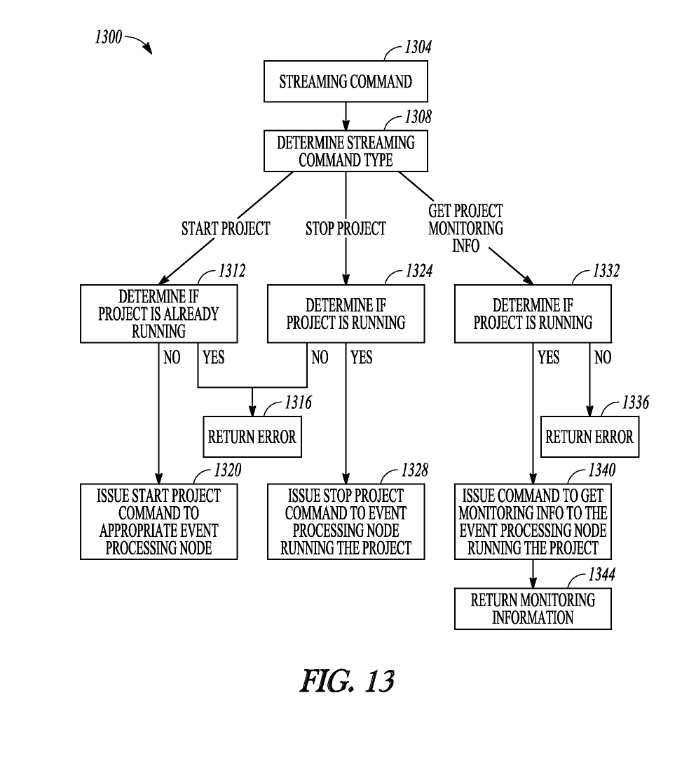

FIG. 13 shows a flowchart of an example method 1300 for an event processing cluster manager 312 in a DBMS 304, in accordance with one example embodiment. In an example embodiment, one or more of the operations of method 1300 may be performed by the cluster manager module 522.

In an example embodiment, a streaming command may be obtained (operation 1304) and the type of streaming command may be determined (operation 1308). If the type of streaming command is a start project command, a test is performed to determine if the project is already running (operation 1312). If the project is already running, an error message may be issued (operation 1316); otherwise, a start project command may be sent to the event processing node 324 that is determined to have an instance of the event processing project 332 identified in the streaming command (operation 1320). If the type of streaming command is a stop project command, a test is performed to determine if the project is already running (operation 1324). If the project is not running, an error message may be issued (operation 1316); otherwise, a stop project command may be sent to the event processing node 324 that is determined to have the event processing project 332 identified in the streaming command (operation 1328).

If the type of streaming command is a get monitoring information command, a test may be performed to determine if the project is already running (operation 1332). If the project is not running, an error message may be issued (operation 1336); otherwise, a get monitoring information command may be sent to the event processing node 324 that is determined to have the event processing project 332 identified in the streaming command (operation 1340). The obtained monitoring information may then be returned (operation 1344).

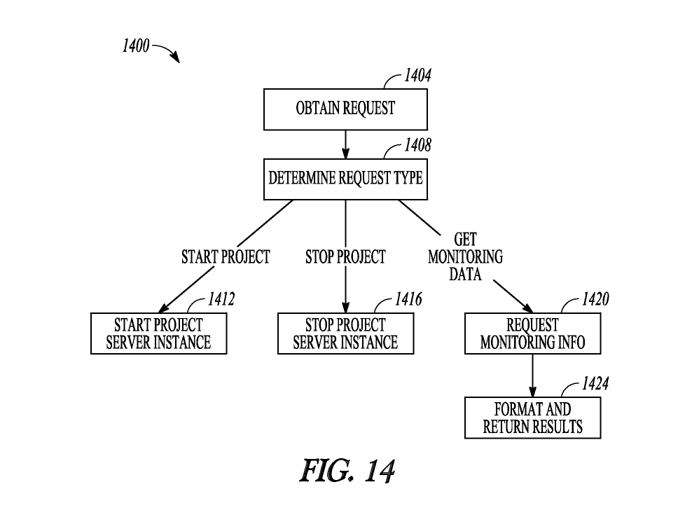

FIG. 14 shows a flowchart of an example method 1400 for an event processing node manager 338 in an event processing node 324, in accordance with one example embodiment.

In an example embodiment, an event processing request may be obtained (operation 1404) and the type of request may be determined (operation 1408). If the type of event processing request is a start project request, the event processing project 332 identified in the event processing request may be started (operation 1412). If the type of event processing request is a stop project request, the event processing project 332 identified in the event processing request may be stopped (operation 1416). If the type of event processing request is a get monitoring information command, the monitoring information for the event processing project 332 identified in the event processing request may be obtained (operation 1420) and the obtained monitoring information may then be formatted and returned (operation 1424).

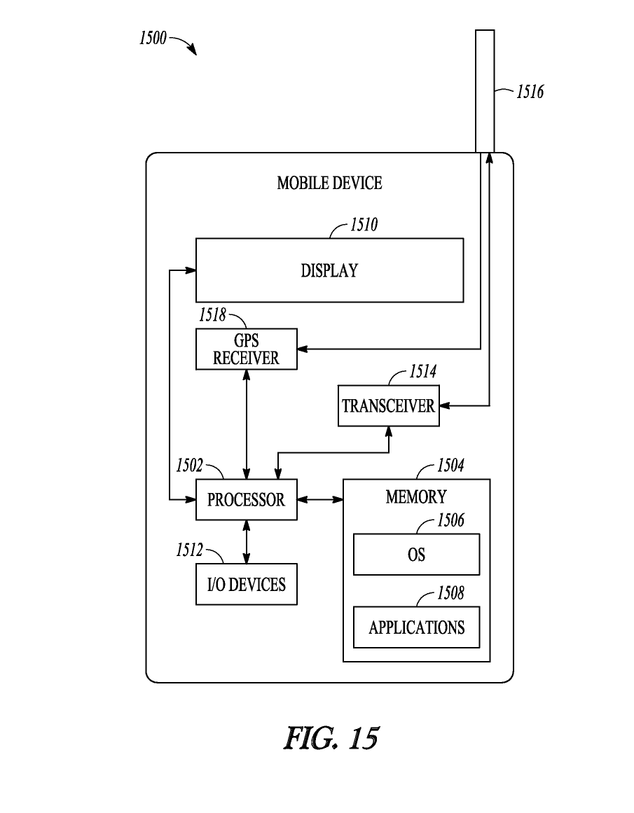

FIG. 15 is a block diagram illustrating a mobile device 1500, according to an example embodiment. The mobile device 1500 can include a processor 1502. The processor 1502 can be any of a variety of different types of commercially available processors suitable for mobile devices 1500 (for example, an XScale architecture microprocessor, a Microprocessor without Interlocked Pipeline Stages (MIPS) architecture processor, or another type of processor). A memory 1504, such as a random access memory (RAM), a Flash memory, or other type of memory, is typically accessible to the processor 1502. The memory 1504 can be adapted to store an operating system (OS) 1506, as well as applications 1508, such as a mobile location enabled application that can provide location-based services (LBSs) to a user. The processor 1502 can be coupled, either directly or via appropriate intermediary hardware, to a display 1510 and to one or more input/output (I/O) devices 1512, such as a keypad, a touch panel sensor, and a microphone. Similarly, in some embodiments, the processor 1502 can be coupled to a transceiver 1514 that interfaces with an antenna 1516. The transceiver 1514 can be configured to both transmit and receive cellular network signals, wireless data signals, or other types of signals via the antenna 1516, depending on the nature of the mobile device 1500. Further, in some configurations, a GPS receiver 1518 can also make use of the antenna 1516 to receive GPS signals.

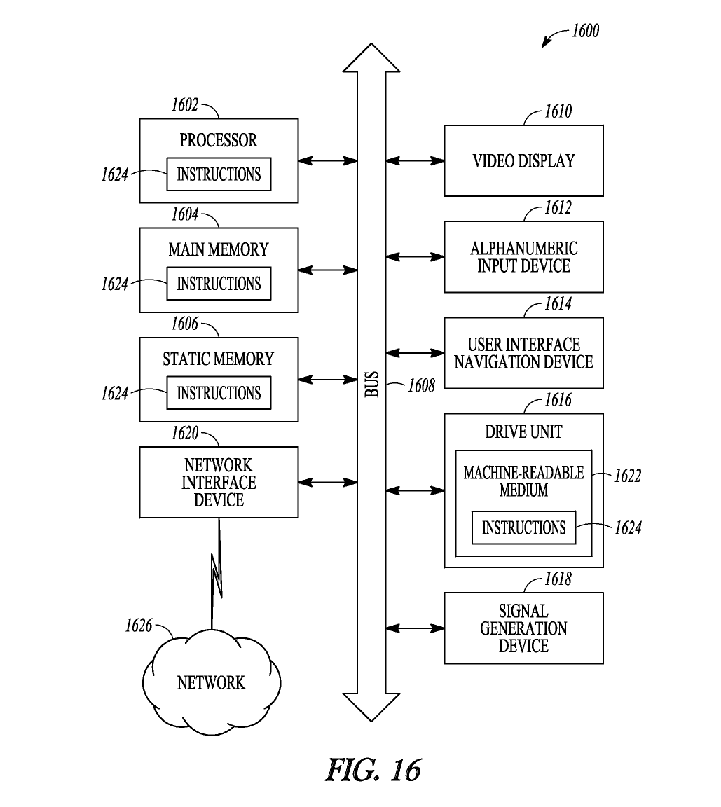

FIG. 16 is a block diagram of a computer processing system 1600 within which a set of instructions 1624 may be executed for causing a computer to perform any one or more of the methodologies discussed herein. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment.

In addition to being sold or licensed via traditional channels, embodiments may also, for example, be deployed by software-as-a-service (SaaS), application service provider (ASP), or by utility computing providers. The computer may be a server computer, a personal computer (PC), a tablet PC, a set-top box (STB), a personal digital assistant (PDA), a cellular telephone, or any processing device capable of executing a set of instructions (sequential or otherwise) that specify actions to be taken by that device. Further, while only a single computer is illustrated, the term “computer” shall also be taken to include any collection of computers that, individually or jointly, execute a set (or multiple sets) of instructions to perform any one or more of the methodologies discussed herein.

The example computer processing system 1600 includes a processor 1602 (e.g., a central processing unit (CPU), a graphics processing unit (GPU), or both), a main memory 1604, and a static memory 1606, which communicate with each other via a bus 1608. The computer processing system 1600 may further include a video display 1610 (e.g., a plasma display, a liquid crystal display (LCD), or a cathode ray tube (CRT)). The computer processing system 1600 also includes an alphanumeric input device 1612 (e.g., a keyboard), a user interface (UI) navigation device 1614 (e.g., a mouse and/or touch screen), a drive unit 1616, a signal generation device 1618 (e.g., a speaker), and a network interface device 1620.

The drive unit 1616 includes a machine-readable medium 1622 on which is stored one or more sets of instructions 1624 and data structures embodying or utilized by any one or more of the methodologies or functions described herein. The instructions 1624 may also reside, completely or at least partially, within the main memory 1604, the static memory 1606, and/or within the processor 1602 during execution thereof by the computer processing system 1600, the main memory 1604, the static memory 1606, and the processor 1602 also constituting tangible machine-readable media 1622.

The instructions 1624 may further be transmitted or received over a network 1626 via the network interface device 1620 utilizing any one of a number of well-known transfer protocols (e.g., Hypertext Transfer Protocol).

While the machine-readable medium 1622 is shown in an example embodiment to be a single medium, the term “machine-readable medium” should be taken to include a single medium or multiple media (e.g., a centralized or distributed database, and/or associated caches and servers) that store the one or more sets of instructions 1624. The term “machine-readable medium” shall also be taken to include any medium that is capable of storing, encoding, or carrying a set of instructions 1624 for execution by the computer and that cause the computer to perform any one or more of the methodologies of the present application, or that is capable of storing, encoding, or carrying data structures utilized by or associated with such a set of instructions 1624. The term “machine-readable medium” shall accordingly be taken to include, but not be limited to, solid-state memories and optical and magnetic media.

While the embodiments of the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A method of processing events, the method comprising:
performing a database operation based on a database query statement being a database operation statement type; and
managing an event processing project based on the database query statement being a non-database operation statement type.

2. The method of claim 1, wherein the managing the event processing project obtains a streaming monitoring view.

3. The method of claim 1, further comprising maintaining event processing projects in a database management catalog.

4. The method of claim 3, wherein one or more event processing artifacts are stored in the database management catalog.

5. The method of claim 1, further comprising authorizing user access to event processing entities via a database manager.

6. The method of claim 1, further comprising maintaining a status of an event processing project in a database management catalog.

7. The method of claim 1, wherein a query processor of a database manager obtains artifacts of an event processing project and issues event processing project commands.

8. The method of claim 1, wherein the database query statement is an SQL statement and the method further comprises:
obtaining a structured query language (SQL) parse tree; and
determining a type of the database query statement based on the SQL parse tree.

9. A system for processing events, the system comprising:
a database management module, implemented using a hardware processor, for performing a database operation based on a database query statement being a database operation statement type; and managing an event processing project based on the database query statement being a non-database operation statement type.

10. The system of claim 9, wherein the database management module is further configured to perform operations comprising maintaining event processing projects in a database management catalog.

11. The system of claim 10, wherein one or more event processing artifacts are stored in the database management catalog.

12. The system of claim 9, wherein the database management module is further configured to perform operations comprising maintaining a status of an event processing project in a database management catalog.

13. The system of claim 9, wherein a query processor of a database manager obtains artifacts of an event processing project and issues event processing project commands.

14. A non-transitory machine-readable storage medium comprising instructions that, when executed by one or more processors of a machine, cause the machine to perform operations comprising:
performing a database operation based on a database query statement being a database operation statement type; and
managing an event processing project based on the database query statement being a non-database operation statement type.

15. The non-transitory machine-readable storage medium of claim 14, further comprising instructions that, when executed by one or more processors of a machine, cause the machine to perform operations comprising maintaining event processing projects in a database management catalog.

16. The non-transitory machine-readable storage medium of claim 15, wherein one or more event processing artifacts are stored in the database management catalog.

17. The non-transitory machine-readable storage medium of claim 14, further comprising instructions that, when executed by one or more processors of a machine, cause the machine to perform operations comprising maintaining a status of an event processing project in a database management catalog.

18. The non-transitory machine-readable storage medium of claim 14, wherein a query processor of a database manager obtains artifacts of an event processing project and issues event processing project commands.

19. The non-transitory machine-readable storage medium of claim 14, wherein the database query statement is an SQL statement and the non-transitory machine-readable storage medium further comprising instructions that, when executed by one or more processors of a machine, cause the machine to perform operations comprising:
obtaining a structured query language (SQL) parse tree; and
determining a type of the database query statement based on the SQL parse tree.

20. A method of processing events, the method comprising:
obtaining a structured query language (SQL) parse tree;
determining a type of SQL statement based on the SQL parse tree;
performing a database operation based on the SQL statement being a database operation statement type; and
managing an event processing project based on the SQL statement being a non-database operation statement type.
